(19) United States
(12) Patent Application Publication
(10) Pub. No.: US 2011/0060635 A1
(43) Pub. Date: Mar. 10, 2011

(54) System and method for motivating healthy eating and a wellness plan related thereto

(75) Inventors: Alan Pollard, Illovo (ZA); Craig Nossel, Jahannesburg (ZA)

(73) Assignee: Discovery Holdings, Ltd.

(21) Appl. No.: 12/660,194

(22) Filed: Feb. 22, 2010

Related U.S. Application Data
(63) Continuation-in-part of application No. 12/262,266, filed on Oct. 31, 2008.

(51) Int. Cl. G06Q 30/00

(52) U.S. Cl. 705/14.17; 705/14.1; 705/1.1

(57) ABSTRACT

A method and system for promoting healthy eating and a managing a wellness program related thereto is disclosed. The method and system includes storing identity data in a database for foods and/or beverages that are determined to be healthy for an individual to consume; receiving purchase information including information for such food and/or beverages and calculating a discount or a refund or reward applicable for the purchase of the product if the at least one food and/or beverage purchased is identified in the identity data. This system and method may optionally be integrated with a wellness program that includes obtaining personal information pertaining to an individual, the personal information including at least the individual's age and gender. In addition, health information pertaining to the individual is obtained. The personal information and the health information are then used to determine a wellness program for the individual, the wellness program including a plurality of program areas with which the individual must comply. Information is then received regarding the individual's compliance or non-compliance with the individual's wellness program and points are awarded to the individual for compliance with the wellness program. At predetermined intervals the total number of points awarded to the individual are calculated and a reward is awarded to the individual based on the total number of points accumulated.

### RELATED APPLICATION

The present application is a continuation-in-part of pending U.S. application Ser. No. 12/262,266, filed Oct. 31, 2008.

### BACKGROUND OF THE INVENTION

The present invention relates to a method of managing a wellness program and a system therefore. Various wellness programs are known which attempt to encourage an individual to look after their wellness. However, these wellness programs often fall short in that they are not personalized for an individual but are rather general wellness programs that are offered to a number of individuals.

One of the effects of general wellness programs is that they lack a personal incentive aspect to motivate the individual to look after their health.

The present invention also relates to a system and method of motivating healthy eating amongst consumers, both by itself and in combination with a wellness program as described above. Prior wellness programs do not encourage healthy eating amongst consumers by directly monitoring what foods the consumers eat. Rather these programs monitor a characteristic of the member such as weight, sugar level or cholesterol level and by monitoring if these go up or down they indirectly monitor the member's eating.

### SUMMARY

According to one example embodiment, there is provided a method of managing a wellness program, the method including: obtaining personal information pertaining to an individual, the personal information including at least the individual's age and gender; obtaining health information pertaining to the individual; using the personal information and the health information to determine a wellness program for the individual, the wellness program including a plurality of program areas with which the individual must comply; receiving information regarding the individual's compliance or non-compliance with the individual's wellness program; awarding points to the individual for compliance with the wellness program; at predetermined intervals, calculating the total number of points awarded to the individual; and awarding a reward to the individual based on the total number of points accumulated.

The health information may include lifestyle factors such as exercise, diet, and smoking, as well as clinical factors such as blood pressure, cholesterol and weight.

The method may include: using the personal information and the health information to determine the health risk of the individual; and using the health risk of the individual as a factor to determine the reward awarded to the individual.

According to another example embodiment there is provided a system for managing a wellness program, the system including: an information obtaining module to obtain personal information pertaining to an individual, the personal information including at least the individual's age and gender and to obtain health information pertaining to the individual; a wellness program determining module to use the personal information and the health related information to determine a wellness program for the individual, the wellness program including a plurality of program areas with which the individual must comply; a monitoring module to receive information regarding the individual's compliance or non-compliance with the individual's wellness program; and an awards module to award points to the individual for compliance the wellness program and at predetermined intervals to calculate the total number of points awarded to the individual and then to award a reward to the individual based on the total number of points accumulated.

The system may include a health risk calculation module to use the personal information and the health information to calculate a relative health risk of the individual.

In this case, the awards module uses the calculated relative health risk of the individual as a factor to determine the reward awarded to the individual.

The health information may include at least one of exercise, diet, smoking, blood pressure, cholesterol and weight.

In one example, the health information is obtained via a communications network.

The health information may be obtained by the information obtaining module transmitting questions via the communications network to the individual and receiving answers from the individual via the communications network such as the Internet.

The plurality of program areas determined by the wellness program determining module may include one or more of manage blood sugar level, reduce cholesterol level, stop smoking, lose weight, increase physical activity, improve diet, reduce alcohol intake.

In addition, the information received regarding the individual's compliance or non-compliance may be received via a communications network.

In one example, the awards module further: defines ranges of points and associates different status levels with each of the ranges of points; determines a status level for the individual based on the amount of points awarded to them; and determines the reward amount based on the status level.

According to another example embodiment, there is provided a method of motivating healthy eating, the method including: storing identity data in a database, the identity data identifying a plurality of foods and/or beverages that are determined to be healthy for an individual to consume; receiving purchase information including information of at least one food and/or beverage purchased by a consumer; accessing the database to ascertain if the at least one food and/or beverage purchased is identified in the identity data; and if the at least one food and/or beverage purchased is identified in the identity data then calculating a discount or a refund applicable for the purchase of the product. The discount or refund may be calculated by a point of sale device. In this example the database may be associated with the point of sale device. Alternatively, the discount or refund may be calculated by a computer separate from the point of sale device. The method further comprises arranging the discount or refund. In one example embodiment, the discount is arranged by transmitting a message to a point of sale device to reduce the cost of the identified food and/or beverage at the point of sale device.

In still another example embodiment, the refund is arranged by transmitting data to a financial provider to refund the consumer for the products purchased. The calculation of the discount or refund may include monitoring of the compliance of the consumer with a wellness program wherein the calculation of the discount is related to the compliance of the consumer with the wellness program. The monitoring of the compliance of the consumer with the wellness program may include: receiving consumer participation information associated with the consumer's participation in the wellness program; and determining, based on the participation information, a status level associated with the consumer for the wellness program, wherein the status level indicates a degree of participation in the wellness program; and altering the calculated discount or refund based on the status revel. The participation information received may include information associated with a plurality of separate and distinct occurrences of wellness program participation by the consumer. The method may further include determining a status level associated with the consumer that further includes: receiving the participation information from an information processing system; assigning a given point value to each separate and distinct occurrence of wellness program participation; determining a total point value based on an accumulation of each given point value assigned to each separate and distinct occurrence of wellness program participation; comparing the total point value to a plurality of point ranges, each point range in the plurality of point ranges being associated with a status level; identifying a point range in the plurality of point ranges corresponding to the total point value; and assigning a status level associated with the point range that has been identified to the consumer. The present invention further includes an electronic system for motivating healthy eating, the system including: a database for storing identity data, the identity data identifying a plurality of foods and/or beverages that are determined to be healthy for an individual to consume; a purchase information module to receive purchase information including information of at least one food and/or beverage purchased by a consumer; a calculation module to access the database to ascertain if the at least one food and/or beverage purchased is identified in the identity data and if the at least one food and/or beverage purchased is identified in the identity data then to calculate a discount or a refund applicable for the purchase of the product.

The discount or refund may be calculated by a point of sale device in which case the database, purchase information module and calculation module are integrated with the point of sale device. Alternatively, the discount or refund may be calculated by a computer separate from the point of sale device. The system may further comprise a discount arranging module to arrange tile discount or refund. In one example embodiment, the discount is arranged by transmitting a message via a communications network to a point of sale device to reduce the cost of the identified food and/or beverage at the point of sale device. In another example embodiment, the refund is arranged by transmitting data via a communications network to a financial provider to refund the consumer for the products purchased. The system may include a wellness program module wherein the calculation of the discount or refund may include monitoring of the compliance of the consumer with a wellness program wherein the calculation of the discount is related to the compliance of the consumer with the wellness program. The monitoring of the compliance of the consumer with the wellness program by the wellness program module may include: receiving consumer participation information associated with the consumer's participation in the wetness program; and determining, based on the participation information, a status level associated with the consumer for the wellness program, wherein the status level indicates a degree of participation in the wellness program; and wherein the calculation module alters the calculated discount or refund based on the status level. The participation information received may include information associated with a plurality of separate and distinct occurrences of wellness program participation by the consumer. The wellness program module may further determine a status level associated with the consumer that further includes: receiving the participation information from an information processing system; assigning a given point value to each separate and distinct occurrence of wellness program participation; determining a total point value based on an accumulation of each given point value assigned to each separate and distinct occurrence of wellness program participation; comparing the total point value to a plurality of point ranges, each point range in the plurality of point ranges being associated with a status level; identifying a point range in the plurality of point ranges corresponding to the total point value; and assigning a status level associated with the point range that has been identified to the consumer.

### BRIEF DESCRIPTION OF THE DRAWINGS

FIG. 1 is a flow chart illustrating the methodology of an example embodiment; and

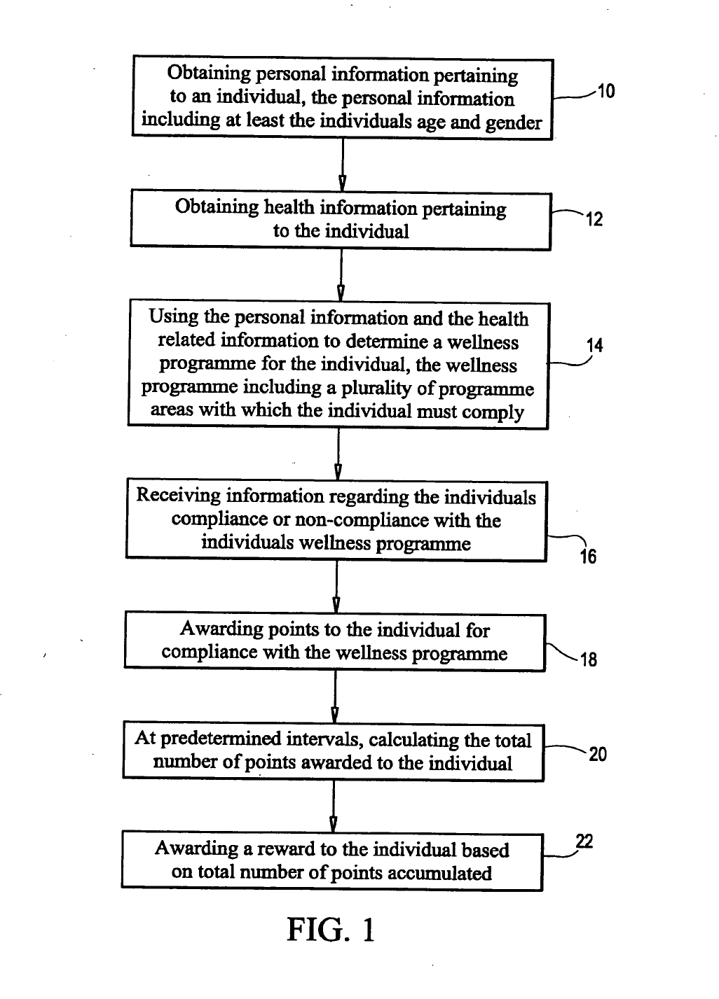

FIG. 2 is a block diagram illustrating an example system to implement the methodologies described herein.

FIG. 3 is a flow chart illustrating the methodology of an example embodiment related to the healthy eating motivational plan of the present invention; and

FIG. 4 is a block diagram illustrating an example system to implement the methodologies described herein.

### DESCRIPTION OF AN EMBODIMENT

Referring to the accompanying diagrams, according to one example embodiment there is provided a method of managing a wellness program.

It will be appreciated that the method and system described below could be implemented by any suitable party acting as the wellness program manager. This would include a health insurance operator, a life insurance operator, an employer that implements the program for their employees or a third party that implements the program on behalf of the above entities. In addition, the wellness program manager could be a separate entity that implements the program and offers it to any individual that wants to join the wellness program which therefore operates as a stand alone program.

In any event, the method includes obtaining personal information pertaining to an individual. The personal information including at least the individual's age and gender.

In addition, the method includes receiving health information pertaining to the individual.

The health information includes lifestyle factors such as exercise, diet, and smoking to name but a few examples, as well as clinical factors such as blood pressure, cholesterol and weight to name but a few examples.

For example, the health information includes information relating to the individual's current health and includes at least some of the individual's eating habits, whether they are a smoker or a non-smoker, their exercise habits and whether or not they have any chronic health conditions to name but a few examples.

The personal information and/or the health information are typically at least partially obtained from the individual by the individual completing a questionnaire.

In one example embodiment the questionnaire is implemented as an interactive tool that the user can access and complete via a communications network. The communications network may be the Internet, for example. In this example, questions are provided to the individual via the Internet and the user's answers are received via the Internet.

In addition to the questionnaire, further health information may be obtained from the individual by requiring the individual to have a number of health related tests. For example these may include one or more of a blood pressure measurement, a blood glucose measurement, a cholesterol test, a tobacco usage test, a cardiovascular health test, a height measurement and a weight measurement.

The personal information and the health related information are then used as part of a health risk assessment and ultimately used to determine a tailored wellness program for the individual.

The wellness program will typically include a plurality of program areas with which the individual must comply.

In addition, the method includes using the personal information and the health information to calculate a relative health risk of the individual and then using the calculated relative health risk of the individual as a factor to determine the reward awarded to the individual.

Based on the health and lifestyle factors which include amount of physical activity, dietary habits, smoking status, as well as existence of certain chronic diseases, the impact of lifestyle behaviors and health parameters for the individual are calculated and shown how this may increase morbidity and mortality. From this the points available are recalibrated so that they are weighted according to the individual's health risk factors. In addition, the scoring helps determine which areas the individual needs to focus on for their health to improve and a pathway for the individual is created to follow where their points are weighted according to their health risks. As the health risks are adjusted, so are their points and program adjusted.

Examples of such wellness programs tailored for individuals are as follows.

Sally is 37 years old, does no exercise, only eats 2 servings of vegetables and fruit daily and is Diabetic. In addition, she smokes, has a raised cholesterol level and is overweight. Her blood pressure is within the normal range, despite having at least 3 whiskeys every evening!

Her calculated health age is 58 or health risk. This is based on the relative risk that her lifestyle and health factors pose. The fact that she smokes adds a certain risk to her from a mortality perspective with regards to chronic diseases of lifestyle. This is represented as an increased age. So each of these factors have a number linked to them with 1.0 being zero risk, less than 1.0 if the lifestyle factor such as exercise provides health benefits thus providing longevity and greater than 1 if a health risk is posed. This calculation will change overtime as new clinical evidence develops.

The overall risk is the difference between Vitality Age and the person's chronological age as a percentage.

A tailored wellness program for Sally highlights the following areas of risk and allocates points to these areas.

TABLE 1

| | Increased Risk | Personal Points |
|---|---|---|
| Diabetes | 76 | 6,000 |
| Cholesterol | 68 | 5,500 |
| Smoking | 53 | 4,500 |
| BMI | 51 | 4,000 |
| Physical activity | 32 | 2,500 |
| Alcohol intake | 29 | 1 |
| Nutrition | 25 | 2,000 |

There are currently no activities or goals linked to alcohol therefore a ‘1’ is inserted. However it will be appreciated that this may not be the case.

The number of points are calculated and allocated based on the individual's overall risk. For example, someone who has a risk that is double what it should be will be allocated 50% more points than someone who is healthy. The additional points that are allocated to the individual will be linked to the various health and lifestyle risk factors that pertain to that individual. Thus the total available points are first calculated and then divided up into the different risk factors based on the weightings associated with those factors.

In this example the diabetes is the most significant risk factor so most of the points are allocated to that factor, then cholesterol etc. If insufficient physical activity is the only risk factor (as per example below) all the additional points will be allocated to that.

Based on the above Sally would be allocated points if she met the following targets.

TABLE 2

| Sally's Personal Pathway | Available points | |
|---|---|---|
| (Programme Areas) | (24 000) | My personal goal |
| Manage your HbA1C | 6 000 | I will reduce my BMI by |
| Reduce your cholesterol | 5 500 | 10% in the next 3 months |
| Stop smoking! | 4 500 | |
| Lose weight | 4 000 | |
| Increase your physical | 2 500 | |
| activity | | |
| Improve your diet! | 2 000 | |
| Reduce your alcohol intake | Referral to | |
| | credible alcohol | |
| | partners (eg AA; | |
| | SANCA) | |

It is worth noting that HbA1C is the hemoglobin A1c test that is a simple lab test that shows the average amount of sugar in a person's blood over the last two to three months. It's an effective way to find out if a person's blood sugar is under control. It will be appreciated that any other suitable test could be used.

Where the goal is defined like stopping smoking Sally will be awarded all of the 4 500 points for stopping smoking and none if she does not.

However, where the goal is not so defined there will typically be amounts associated with the goal. So Sally will be asked to lose a certain amount of weight before she is allocated the 4 000 points for losing weight. This may be tiered so that reaching certain thresholds will give the individual access to certain rewards or greater rewards

The personal goal column is suggested by Sally after she has been shown what her risk factors are and she is then provided with additional incentive (points) to set a particular short term goal which she can choose from the list.

In another example, Bob is 31 years old, finds exercise difficult and does not like vegetables & fruit. He smokes and drinks alcohol in excess. Despite his unhealthy lifestyle habits, his health measurements are all in the normal range.

His calculated health age is 37.

A tailored wellness program for Bob highlights the following areas of risk and allocates points to these areas.

TABLE 3

| | Increased Risk | Personal Points |
|---|---|---|
| Smoking | 53 | 4,500 |
| Physical activity | 32 | 2,500 |
| Alcohol | 29 | 1. |
| Nutrition | 25 | 2,000 |

Based on the above Bob would be allocated points if he met the following targets:

TABLE 4

| My Personal Pathway | Available points | |
|---|---|---|
| (Programme Areas) | (9 000) | My personal goal |
| Stop smoking! | 4 500 | I will quit in the next 3 |
| Increase your physical activity | 2 500 | months |
| Improve your diet! | 2 000 | |
| Reduce your alcohol intake | Referral to | |
| | credible alcohol | |
| | partners (eg AA; | |
| | SANCA) | |

In a further example, Alan is a healthy 40 year old male but needs encouragement to exercise a bit more—he currently manages about 45 minutes per week. His vegetable and fruit intake is average (4 servings daily) and his cholesterol is 4.5 mmol/l.

His calculated health age is 41.

A tailored wellness program for Alan highlights the following areas of risk and allocates points to these areas.

TABLE 5

| | Increased Risk | Personal Points |
|---|---|---|
| Physical activity | 32 | 1,000 |
| Nutrition | 25 | 500 |
| Cholesterol level | 23 | 500 |

Based on the above Alan would be allocated points if he met the following targets.

TABLE 6

| | Available | |
|---|---|---|
| | points | |
| My Vitality Personal Pathway | (2 000) | My personal goal |
| Increase your physical activity | 1 000 | I will become fit enough to |
| Improve your diet! | 500 | reach level 4 at my next |
| Manage your cholesterol | 500 | Vitality Fitness |
| | | Assessment! |

In a final example, at 25 Jacoline is the picture of health. Her healthy lifestyle is keeping her calculated health well below her actual age!

Her calculated health age is 22.5.

Her only goal is therefore to maintain her current status.

Jacoline may obtain points based on a general wellness program points structure i.e. for going to gym, but will not be given any additional points as she is not at risk.

In order to assist the individual comply with their program, they are assisted with access to the facilities and/or services required by them. For example, the member's gym membership is at least partially subsidized to allow the member more affordable access to the gym. This may be implemented by entering into an agreement with designated gyms whereby at least a portion of the member's gym fees are paid on behalf of the member or where a reduced fee is negotiated on the member's behalf.

Similar access would be afforded to the member to other health related facilities and or services such as to a smoke ending program or a weight loss program, for example.

Once the member has their wellness program, information is received periodically regarding the individual's compliance or non-compliance with their wellness program.

In one embodiment, this information is typically received directly from the third party health related facilities and or services. By way of illustration, the gym which the member attends may collect information on the member's attendance at the gym and then periodically pass this information onto the managers of the wellness program. This information can be passed on via a communications network between the gym, for example, and the manager of the wellness program.

The member may also be required to again complete the questionnaire described above and/or re-submit themselves for testing at periodic intervals and the results of this testing and questionnaire are then used to assess the member's compliance with their individual program.

Points are awarded to the individual for compliance with the wellness program and in accordance with their personal targets that have been set out for them.

At predetermined intervals, the total number of points awarded to the individual is calculated and a reward is then awarded to the individual based on the total number of points accumulated.

In one example, the points are used to determine a status level so that points falling within specific ranges are associated with a status level. In one example, the status levels could be blue, bronze, silver, gold and platinum with blue being the lowest level and platinum being the highest level. The reward amount is then linked to the status level.

The reward could take any one of a number of forms including one or more of cash payments; discounts on purchases at partner stores; reduced or free airline tickets, hotel accommodation and car rental; donations to a charity of choice of the member—to name but a few examples.

The amount of the reward is related to the total number of points awarded to the individual, in one example by using the status levels described above.

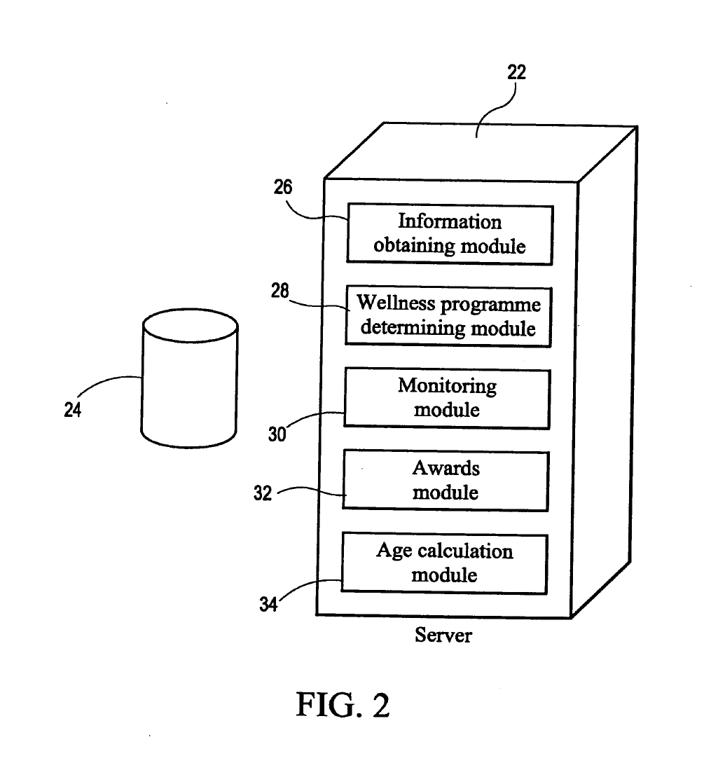

Referring to FIG. 2, there is provided an example embodiment of a system for implementing the abovementioned method of managing a wellness program.

The system includes a processor included in a server 22 disposed in communication with a memory 24.

The processor 22 includes modules which are implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

The system includes an information obtaining module 26 to obtain personal information pertaining to an individual, the personal information including at least the individual's age and gender and to obtain health information pertaining to the individual.

As described above, in one example embodiment, the information obtaining module 26 provides an on-line questionnaire to the individual to be completed by the individual interactively. The individual's answers to the questionnaire are stored in the memory 24 which may take the form of a database.

A wellness program determining module 28 uses the personal information and the health related information to determine a wellness program for the individual, the wellness program including a plurality of program areas with which the individual must comply as has been described above.

A monitoring module 30 receives information regarding the individual's compliance or non-compliance with the individual's wellness program and an awards module 32 awards points to the individual for compliance the wellness program and at predetermined intervals to calculate the total number of points awarded to the individual and then to award a reward to the individual based on the total number of points accumulated as has been described above.

The system also includes a relative health risk calculation module 34 to use the personal information and the health information to calculate a relative health risk of the individual.

In this case, the awards module uses the calculated relative health risk of the individual as a factor to determine the reward awarded to the individual.

Thus it will be appreciated that a wellness program is tailored for an individual rather than the individual having to comply with a general wellness program.

Still a further embodiment of the present invention relates to the application of systems and methodology as described herein for motivating a consumer to healthy eating, both as an integrated component of a wellness program as described above, and as an independent, stand alone program. Existing wellness programs do not generally encourage healthy eating amongst consumers by directly monitoring what foods the consumers eat. Rather these programs monitor a characteristic of the member such as weight, sugar level or cholesterol lever and by monitoring if these go up or down they indirectly monitor the member's eating. In addition, with much hype around food and food labels it is not always clear to the consumer which purchases are actually healthy food and what is mere marketing. Thus, there is also a need to indicate simply to consumers what is a healthy choice of food and/or beverage.

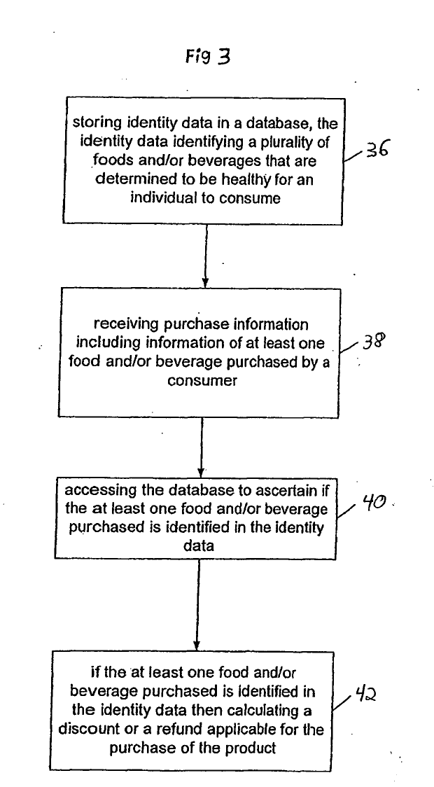

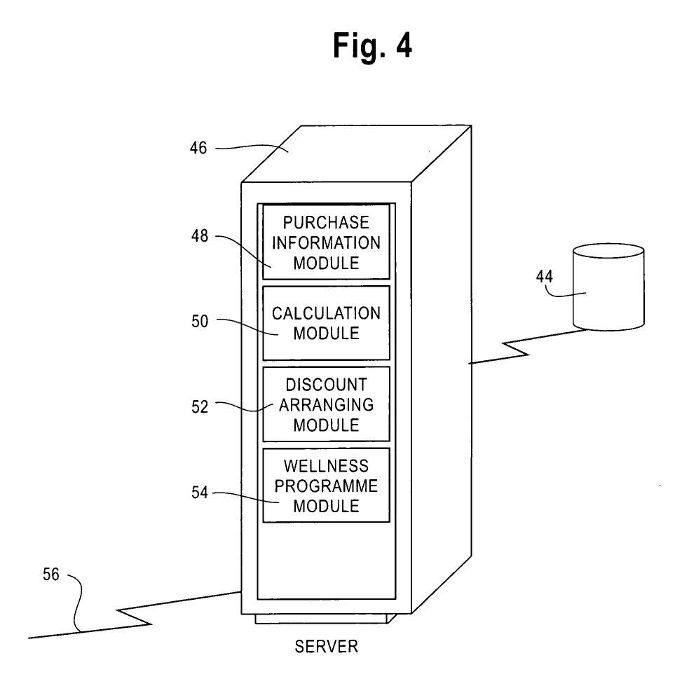

Referring to the accompanying diagrams of FIGS. 3 and 4, identity data is stored (block 36) in a database 44, the identity data identifies a plurality of food and/or beverages that are determined to be healthy for an individual to consume. It will be appreciated that where these are offered to the consumer for sale, the food and/or beverages that are identified to be healthy for an individual to consume will be in some way marked, for example using a logo on the packaging, to bring these to the consumer's attention. In this way the identification of healthy food can be taken out of the consumer's hands and placed in the hands of experts who are able to use scientific research and World Health Organization guidelines to select these. In block 38 purchase information is received which includes information of at least one food and/or beverage purchased by a consumer. This purchase information is received typically at a server 46 which is associated with the database 44. It will be appreciated that although this is depicted as a server including a number of modules, the purchase information could be received at any other suitable processor, module or computer, for example.

In addition, the server, modules and database could be a stand alone system or could together or separately form part of one or more larger systems. For example, one or more of the server, modules and database could form part of a point of sale system or could be incorporated as one or more additional modules to a point of sale system as will be described below in more detail. Alternatively, one or more of the server, modules and database could form part of a system of an existing institution such as a financial service provider institution or could be incorporated as one or more additional modules to such a system. In any event, the database is accessed (block 40) to ascertain if the at least one food and/or beverage purchased is identified in the identity data. If it is identified this effectively means that the food is determined to be healthy for the consumer. If the at least one food and/or beverage purchased is identified in the identity data then a discount or a refund applicable for the purchase of the product is calculated. Obviously for a discount in the pure sense of the word to be given the database and server will need to be incorporated into the point of sale device or closely linked to the point of sale device so that at the time of registering the sale the point of sale device is able to work out the discount to be presented to the user for payment in real time. For a refund, the server and database can calculate the refund after the time of sale and so although they need to be in data communication with the point of sale system this connection does not necessarily need to be in real time. It will be appreciated that for a refund embodiment, the server will need receive data not only indicating what food and/or drinks were purchased but also the identity of the consumer that purchased the products.

This is implemented by entering the identity of the consumer at the point of sale device. This can either be done manually by the point of sale operator or the point of sale operator can swipe an identity card belonging to the consumer that identifies the consumer. Alternatively, the consumer's identity can be obtained if they use a financial instrument such as a credit card or a debit card, for example, from which their identification can be gleaned.

Thus the server or database will receive data from the point of sale system and use the data to calculate the refund. In one example embodiment the discount or refund is a fixed amount or a fixed percentage of the sales price. In other embodiments the discount amount could differ depending on the food or beverage so that the healthier a food and/or beverage is determined to be the greater the discount. In another example embodiment the discount or refund could be calculated on each food and/or beverage individually or could be calculated on a total of all purchased amounts whereby the percentage discount or refund is related to the number of healthy foods and beverages purchased. In this case the larger the number the greater the discount, for example. Alternatively there could be discount bands where the total number of foods and/or beverages purchased will fall within a band and the amount of the discount is related to the band. In yet another example embodiment the compliance of the consumer with a wellness program is monitored and integrated into one or more of the above calculations. An example of such a wellness program is presently managed by the applicant that manages a traditional life and health insurance plan together with their wellness program disclosed in the applicant's South African granted patent number ZA 99/1746, the contents of which are incorporated herein by reference. However, it will be appreciated that other wellness programs could be used and integrated with this calculation. In an example wellness program, members participate in approved related facilities and/or services. For example, members use gymnasiums, Smoke Enders™ and Weighless™. In one example, members are awarded points and depending on the total number of points allocated to a member, they fall within one of five statuses. In the implementation of the wellness program, these statuses have been named in ascending order of value, blue, bronze. silver, gold and diamond. All members are placed initially in the blue status. Once a member has accumulated a predetermined number of points, his/her status is upgraded to the next appropriate level.

It will be appreciated that for purposes of the present invention the wellness program could be operated by the provider of the healthy food program or could be operated by a third party that operates the wellness program and then inform the provider of the healthy food program the degree of participation of the consumer with the wellness program.

This could occur by a third party transmitting data to the server as shown in FIG. 4. The data is received at the at least one server 46 and stored in the database associated with the server or in another database. In one example the data will include at least an identity of the consumer and data identifying the status of the consumer, for example blue, bronze, silver, gold and diamond. In another example, in order to determine the status, a monitoring of the compliance of the consumer with the wellness program includes receiving consumer usage information associated with the consumer's usage of the wellness program and determining, based on the usage information, a status level associated with the consumer for the wellness program, wherein the status level indicates a degree of participation in the wellness program The usage information received may include information associated with a plurality of separate and distinct occurrences of wellness program participation by the consumer. In addition, the method may further include determining a status level associated with the consumer that further includes receiving the usage information from an information processing system and assigning a given point value to each separate and distinct occurrence of wellness program participation.

A total point value is determined based on an accumulation of each given point value assigned to each separate and distinct occurrence of wellness program participation The total point value is then compared to a plurality of point ranges, each point range in the plurality of point ranges being associated with a status level and identifying a point range in the plurality of point ranges corresponding to the total point value. Finally, a status level is assigned that is associated with the point range that has been identified to the at least one employee. Then based on the degree of participation of the consumer with the wellness program the discount or refund is altered (block 16). An example of the above is as follows:

### Status

| Blue | Bronze | Silver | Gold | Diamond |
|---|---|---|---|---|
| 75% | 17% | 20% | 22% | 25% |

Thus where the consumer is blue status then 15% of their spending on healthy food will be paid discounted or paid back to them as a refund. It will be appreciated that the methodology works particularly well when implemented in conjunction with a wellness program and associated credit or debit card which is issued to the consumer. This is because the consumer can continue to purchase the necessary goods using the credit or debit card and certain entries in the card will be automatically discounted or refunded depending on the consumer's status. It will also be appreciated that the healthy food program may work particularly well when implemented on behalf of an insurer such as a health insurer or life insurer as good health of members of such insurance schemes leads to reduced claims on the insurance scheme. FIG. 4 illustrates an exemplary system for implementing the above methodologies. A server 46 includes a number of modules to implement the methodologies described above. A database 44 is used for storing identity data identifying a plurality of foods and/or beverages that are determined to be healthy for an individual to consume. A purchase information module 48 receives purchase information including information of at least one food and/or beverage purchased by a consumer. A calculation module 50 is used to access the database 44 to ascertain if the at least one food and/or beverage purchased is identified in the identity data and if the at least one food and/or beverage purchased is identified in the identity data and then to calculate a discount or a refund applicable for the purchase of the product. The system may further comprise a discount arranging module 52 to arrange the discount or refund. In one example embodiment, the discount is arranged by transmitting a message via a communications network 56 to a point of sale device to reduce the cost of the identified food and/or beverage at the point of sale device. In another example embodiment, the refund is arranged by transmitting data via a communications network 56 to a financial provider to refund the consumer for the products purchased.

The system also includes a wellness program module 54 wherein the calculation of the discount or refund includes monitoring of the compliance of the consumer with a wellness program as described above and wherein the calculation of the discount is related to the compliance of the consumer with the wellness program. The monitoring of the compliance of the consumer with the wellness program by the wellness program module 54 in one example includes receiving consumer participation information associated with the consumer's participation in the wellness program and determining, based on the participation information, a status level associated with the consumer for the wellness program, wherein the status level indicates a degree of participation in the wellness program. The calculation module 50 alters the calculated discount or refund based on the status level. The participation information received may include information associated with a plurality of separate and distinct occurrences of wellness program participation by the consumer.

The wellness program module 54 further determines a status level associated with the consumer by receiving the participation information from an information processing system and assigning a given point value to each separate and distinct occurrence of wellness program participation as described above. In any event, it will be appreciated that the modules described above may be implemented by a machine-readable medium embodying instructions which. when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

We claim:

1. A method of motivating healthy eating, the method comprising:
a) Providing identity data to a database, the identity data including values for a plurality of foods that are determined to be healthier;
b) Receiving purchase information into said database, said purchase information including information of at least one food purchased by a consumer; and
c) Calculating a reward applicable for the food purchased by the consumer based upon a comparison of said food and said identity data.

2. The method of claim 1, wherein said reward is a discount provided to the consumer deducted from the price of said food purchased.

3. The method of claim 1, wherein said reward is in the form of reward points credited to a purchaser account for subsequent use.

4. The method of claim 1, wherein the step of calculating occurs at the point of sale.

5. A method of promoting the development and maintenance of healthy food purchasing practices, said method comprising:
a) Establishing a variable purchase reward relationship for a purchaser based at least in part upon the purchase of preferred foods;
b) Providing a database for receiving purchasing information related to said purchase of preferred foods by said purchaser;
c) Calculating a reward for said purchaser based at least in part upon said purchase of preferred foods; and
d) Adjusting the purchase reward relationship for said purchaser based at least in part upon the transactional history of said purchaser, said history including at least the purchase of said preferred foods and health information of said purchaser.

6. The method of claim 5, wherein said health information of said purchaser includes a participation level value related to a wellness program.

7. The method of claim 5, wherein the variable purchase reward relationship includes a plurality of values for each of said preferred foods, each of the plurality of values for a given preferred food corresponding to a participation level value related to a wellness program.

8. The method of claim 5, wherein the variable purchase reward relationship uses a formula for calculating said reward, said formula further including a variable representing a participation level value related to a wellness program.

9. A method of promoting the development and maintenance of a healthy food purchasing program, said method comprising;
a) Identifying preferred foods to be purchased for a variety of purchasers;
b) Providing a plurality of values for at least one of said preferred foods; and
c) Generating a reward upon receipt of purchasing information from a purchaser, the generation of the reward being based upon at least one of the plurality of values and health related information of the purchaser,
whereby the reward provided is dependent at least in part upon the health of the purchaser so as to increase the efficacy of the healthy food purchasing program.

10. The method of claim 9, wherein the reward provided to a purchaser is dependent at least in part upon a participation level value of said purchaser related to a wellness program.

11. The method of claim 10, wherein said reward increases when said participation level value increases for said purchaser.
